(19) United States
(12) Patent Application Publication
(10) Pub. No.: US 2026/0027602 A1
(43) Pub. Date: Jan. 29, 2026

(54) VESSEL RINSING DEVICE

(71) Applicant: Kohler Co., Kohler, WI (US)

(72) Inventor: Carlos UCEDA, Kohler, WI (US)

(21) Appl. No.: 19/266,855

(22) Filed: Jul. 11, 2025

Related U.S. Application Data
(60) Provisional application No. 63/675,855, filed on Jul. 26, 2024.

(51) Int. Cl. B08B 9/093

(52) U.S. Cl. CPC B08B 9/093; B08B 2203/005; B08B 2203/0217; B08B 2209/08

(57) ABSTRACT

A vessel rinsing device for applying pressurized fluid to a vessel or other similar container with the objective of cleaning and rinsing the vessel or container. A vessel rinsing device may include a mounting element including a base and a nozzle body extending upwardly from the base along a longitudinal axis substantially perpendicular to a surface to which the vessel rinsing device is mounted, and a rinser body mounted to the base. A caddy surface can also be coupled to the rinser body. The nozzle can rotate to spray fluid around the interior of the vessel.

### RELATED APPLICATIONS

This application claims the benefit of U.S. Provisional Application Ser. No. 63/675,855, filed Jul. 26, 2024, which is incorporated herein by reference in its entirety.

### TECHNICAL FIELD

The present disclosure generally relates to a fluid dispensing device. More specifically, the present disclosure relates to a fluid and soap dispensing device couplable to a sink deck and configured for use with vessels and other similar fluid containers.

### BACKGROUND

It is often difficult to clean the interior of a vessel such as a glass or a cup. Debris can become lodged deep inside the vessel which makes cleaning challenging especially when the vessel has a small diameter opening. Conventional approaches to cleaning vessels include, for example, brushes, rags, spray faucets, or simply placing the dirtied vessel in a dishwasher for automatic cleaning. While these approaches may prove effective on occasion, they typically leave at least some debris in hard-to-reach areas deep inside the vessel that cannot be removed without recleaning the vessel using a different approach. Moreover, these approaches are either excessive (e.g., spray faucets, dishwasher) or require too much manual labor from the vessel cleaner (e.g., brushes, rags).

Other more recent approaches include using a vessel rinsing apparatus connected to a sink deck surface to provide pressurized water directly into the vessel when a force is applied against the apparatus. While these more recent approaches tend to remedy the issue of providing water directly to hard-to-reach areas, they typically do not integrate soap or another cleaning product into the directed water stream when cleaning the vessel. Accordingly, the current line of vessel rinsing apparatuses fail to provide complete vessel cleanliness because they do not remove all germs, chemicals, and other unsavory substances removeable only through the use of a combination of water and a cleaning product. Examples of the present disclosure provide solutions to this problem as well as other problems that will become apparent in subsequent sections herein.

### SUMMARY

Examples of the present disclosure relate to a vessel rinsing device configured to apply pressurized water to a vessel or other similar container with the objective of cleaning and rinsing the vessel or container. In examples, a vessel rinsing device may include a mounting element including a base and a nozzle body extending upwardly from the base along a longitudinal axis substantially perpendicular to a surface to which the vessel rinsing device is mounted, and a rinser body mounted to the base. The mounting element may be mounted to a surface, such as a sink deck, via a hollow mounting shank or other mounting hardware, which is operable coupled to a fluid source.

The rinser body may generally include a sidewall forming a bowl, and an aperture through which the nozzle body is configured to extend to mount the rinser body to the base. An internal surface of the bowl may provide a surface for supporting a vessel placed thereon, and optionally a channel for draining fluid out of the bowl and into a basin. Optionally, the internal surface may include a hydrophobic layer, such as a silicon layer. The channel terminates in an opening formed in the sidewall. Further, the internal surface may include a collar through with the nozzle body extends, and the rinsing body may be easily removed therefrom for cleaning. Optionally, one or more light-emitting diodes for providing illumination during vessel cleaning operations, such as an orientation of the vessel rinser with respect to a sink basin is formed on the base or other surface.

The nozzle body has a first end coupled to the base, and a second end terminating in one or more fluid delivery nozzles. The rinser body is configured to move along the longitudinal axis when a vessel is placed on the internal surface and pressed downward. A valve assembly housed in the nozzle body, base, or in a mounting assembly is then opened to allow fluid to be discharged nozzles. In an example, the nozzle body rotates upon actuation, thereby spraying fluid in and around in an interior of the vessel.

In another example, a vessel rinsing device includes a nozzle body extending through and into a rinsing body secured to a sink deck or other surface. The nozzle body includes one or more nozzles for discharging fluid, and may optionally rotate, upon actuation. A trigger, such as plurality of arms or a trigger plate, is coupled to the nozzle body and may be moved downwardly along the nozzle body to actuate a valve assembly for fluid discharge. The rinsing body further includes a removable caddy surface adjacent the nozzle body and trigger. A drain channel may be formed in the rinser body sidewall, and optionally below the caddy surface, for draining fluid from the nozzle body and/or the caddy surface.

In other examples, a method of operating a vessel rinsing device may include positioning a dirtied vessel above a vessel rinsing device for cleaning and rinsing. The method may include exerting force using the dirtied vessel against a trigger mechanism of the vessel rinsing device, for example a plurality of arms or the rinser body itself. The method may include activating water dispersal through a plurality of nozzles defined within a dome of the vessel rinsing device, in response to the exertion of force, and thereafter directing the water dispersal into the dirtied vessel for cleaning and rinsing. The method may include removing the cleaned vessel from the trigger mechanism which stops the flow of water through the plurality of nozzles and effectively turns off the vessel cleaning device.

### BRIEF DESCRIPTION OF THE DRAWINGS

The disclosure may be more completely understood in consideration of the following detailed description of examples of the disclosure in connection with the accompanying drawing, in which:

FIG. 1 is a perspective view of a vessel rinsing device, according to an example of the present disclosure;

FIG. 2 is a front view of the vessel rinsing device of FIG. 1;

FIG. 3 is a left side view of the vessel rinsing device of FIG. 1;

FIG. 4 is a top view of the vessel rinsing device of FIG. 1;

FIG. 5 is a perspective view of a mounting element of the vessel rinsing device of FIG. 1, and according to an example of the present disclosure;

FIG. 6 is a process diagram of rinser body removal and installation of the vessel rinsing device of FIG. 1.

FIG. 7 is a side-by-side comparison of the vessel rinsing device of FIG. 1 in a starting position and a working position;

FIG. 8 is a perspective view of a vessel rinsing device with caddy, according to an example of the present disclosure;

FIG. 9 is a front view of the vessel rinsing device of FIG. 8;

FIG. 10 is a left side view of the vessel rinsing device of FIG. 8;

FIG. 11 is a top view of the vessel rinsing device of FIG. 8;

FIG. 12 is a side-by-side comparison of the vessel rinsing device of FIG. 8 in a starting position and a working position; and

FIG. 13 is an exploded view of the vessel rinsing device of FIG. 8.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION

The following detailed description should be read with reference to the drawings in which similar elements in different drawings are numbered the same. The drawings, which are not necessarily to scale, depict illustrative examples and are not intended to limit the scope of the disclosure.

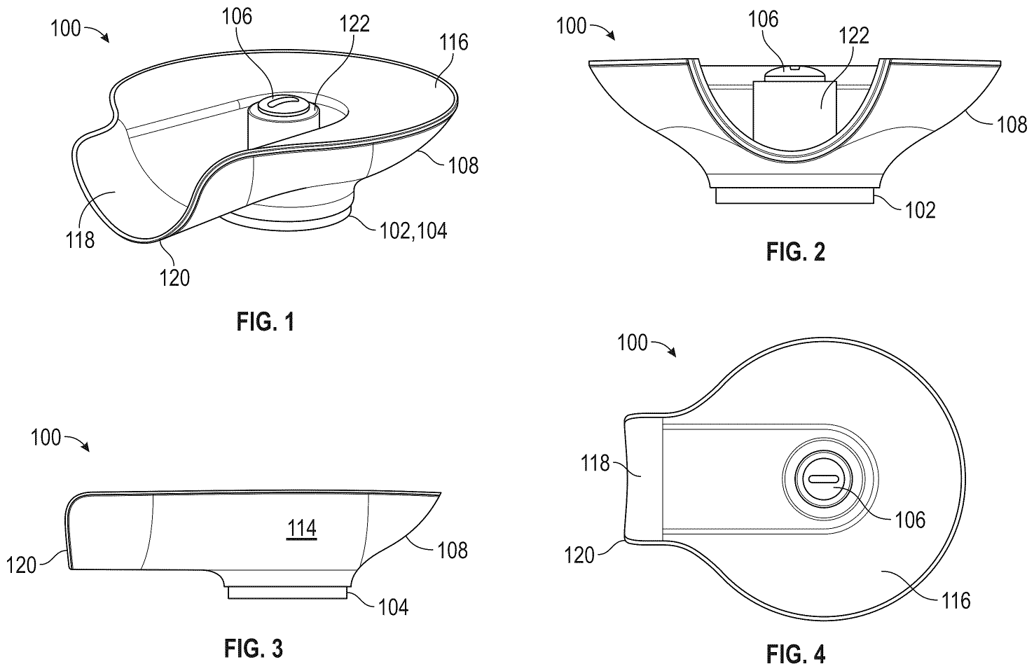

Referring to FIGS. 1-5, a vessel rinsing 100 device generally includes a mounting element 102 including a base 104 and a nozzle body 106 extending upwardly from the base 104 along a longitudinal axis substantially perpendicular to a surface to which the vessel rinsing device is mounted, and a rinser body 108 mounted to the mounting element 102. The mounting element 102 may be mounted to a surface, such as a sink deck, via a hollow mounting shank (not shown) or other mounting hardware, which is operable coupled to a fluid source.

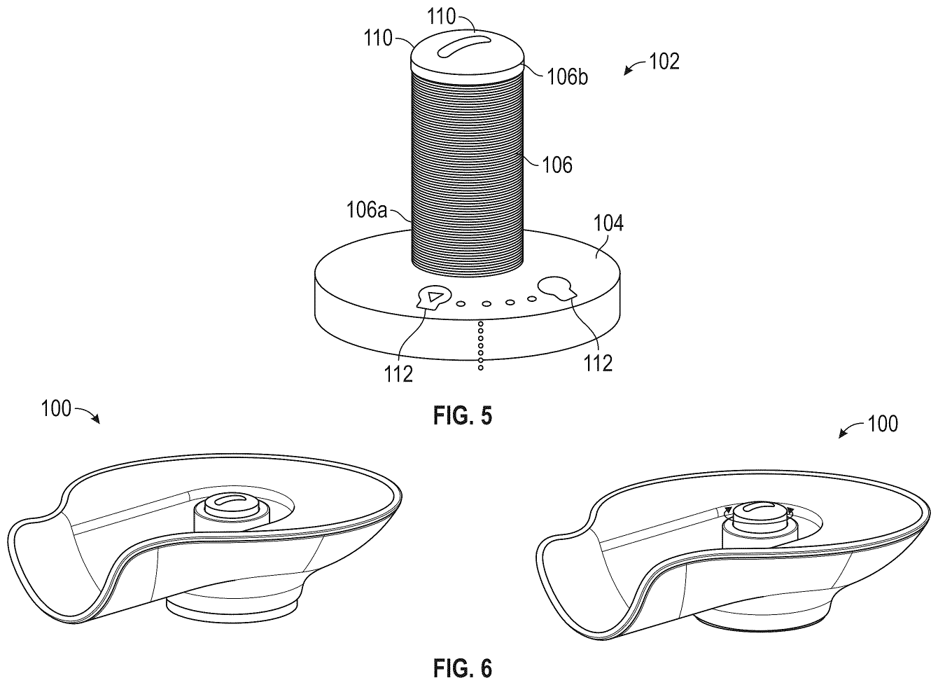

Referring to FIG. 5, the nozzle body 106 has a first end 106a coupled to the base 104, such as by threaded coupling or other, and a second end 106b terminating in one or more fluid delivery nozzles 110. The nozzle body 106 is configured to rotate with respect to the base 104. Optionally, one or more light-emitting diodes 112 for providing illumination during vessel cleaning operations or installation operations, such as an orientation of the vessel rinser with respect to a sink basin, is formed on the base 104 or other surface.

Turning back to FIGS. 1-4, the rinser body 108 generally includes a sidewall 114 forming a bowl, and an aperture (not shown) sized to fit the base 104, and through which nozzle body 106 is configured to extend to mount the rinser body 108 to the base 104. An internal surface 116 of the bowl may provide a surface for supporting a vessel placed thereon, and optionally includes structure defining a channel 118 for draining fluid out of the rinser body 108 and into a basin (not shown). Optionally, the internal surface 116 may include a hydrophobic layer, such as a silicon layer, while the sidewall 114 may be formed of metal, plastic, composite or any of a variety of materials. The channel 118 terminates in an opening 120 formed in the sidewall. Further, the internal surface may include a collar 122 through with the nozzle body 106 extends.

Referring to FIG. 6, the rinser body 108 acts as a trigger or actuator and is configured to move along the longitudinal axis when a vessel is placed on the internal surface 116 and pressed downward. The nozzle body 106 may or may not move with the rinser body 108. A valve assembly (not shown) housed in the nozzle body 106, base 104, or in a mounting assembly (not shown) or below deck (not shown) is then opened to allow fluid to be discharged nozzles 110. In an example, the nozzle body 106 rotates upon actuation, thereby spraying fluid, such as water, ozonated water, soapy water, or other disinfectant, in and around in an interior of the vessel until the downward force on the rinser body 108 is removed, at which time the rinser body 108 moves to its starting position and the valve assembly closes.

The mounting assembly, though not explicitly shown in the figures, may be configured to couple vessel rinsing device 100 to a sink deck so device 100 may be operated in the manner contemplated by this disclosure. The mounting assembly is couplable to the mounting element 102 via the base 104 or nozzle body 106, and is also couplable to the sink deck. The mounting assembly may have, for example, a cylindrically shaped geometry with threaded upper and lower portions to enable effective coupling to the sink deck. The sink deck generally defines an aperture through which the mounting assembly extends through, thereby enabling the bottom surface of the lower base 104 to rest directly on a top surface of the sink deck when the mounting assembly is coupled to the sink deck. Mounting assembly is generally made from a metallic material, though other suitable materials such as insoluble polymers, composite materials, and ceramics may be used. The length, width, diameter, and other measurements of mounting assembly may vary depending on the type of sink deck being used, the proximity of the sink deck to external plumbing features, and/or the preferences of the user of the vessel rinsing device 100.

In order to enable water transport to the vessel rinsing device 100, the mounting assembly generally may define an internal chamber extending from one open end to another open end. For example, the mounting assembly may define a first opening configured to receive a water transport element such as a hose or another suitable water passageway. The water transport element may extend through the internal chamber such that it is in fluid communication with the nozzle body 016 of the vessel rinsing device 100. Accordingly, mounting assembly additionally enables the transport of water or other fluids from an external source to other components of vessel rinsing device 100, in order to be used for vessel rinsing operations.

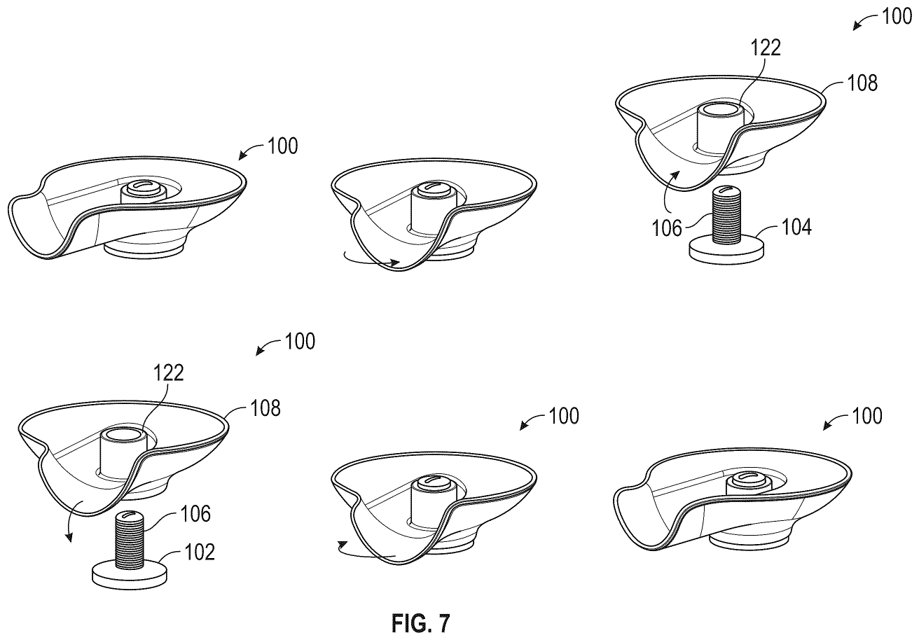

Referring to FIG. 7, rinser body 108 may be easily removed from mounting element 102 by rotating the body 108 relative to the base 104, and pulling upwardly to release rinser body 108 from nozzle body 106. The rinser body 108 may be cleaned or replaced entirely. For installation, rinser body 108 is received on nozzle body 016 via collar 122 until it mates with base 104. Rinser body 108 is then rotated (e.g. 10-20 degrees) until the channel 118 and opening 120 align with the sink basin. In an example, rinser body 108 may only be actuated with channel 118 and opening 120 are aligned with the sink basin.

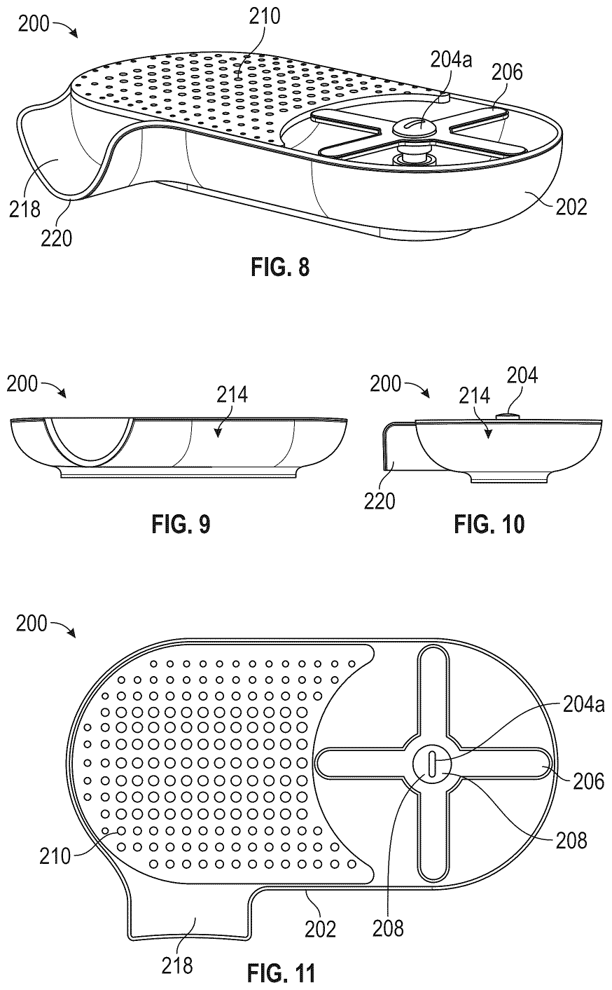

Now referring to FIGS. 8-11, a vessel rinsing device 200 may include a rinser body 202 in the form of a bowl, and a nozzle body 204 (as described above) configured to extend through an aperture formed in the bottom of the base 202. A trigger 206 in the form of a series of radially extending arms 208 or a trigger plate (not shown) is coupled to a second end 204b with nozzles 208 formed thereon.

The rinser body 202 generally includes a sidewall 214 forming a bowl, and an aperture (not shown) to receive a mounting assembly (not shown) as described above, and through which nozzle body 204 is configured to extend to mount the rinser body 202 to nozzle body 204. An internal surface 216 of the bowl may provide a ledge or ridges 217 for removably receiving a caddy surface 210 adjacent the nozzle body 204 and trigger 206 for supporting a vessel placed thereon for draining and/or drying. Rinser body 202 optionally includes structure defining a channel 218 for draining fluid out of the rinser body 202 and into a basin (not shown). Optionally, the internal surface 216 may include a hydrophobic layer, such as a silicon layer, while the sidewall 214 may be formed of metal, plastic, composite or any of a variety of materials. The channel 218 terminates in an opening 220 formed in the sidewall. Further, the internal surface may include a collar (not shown) through with the nozzle body 204 extends.

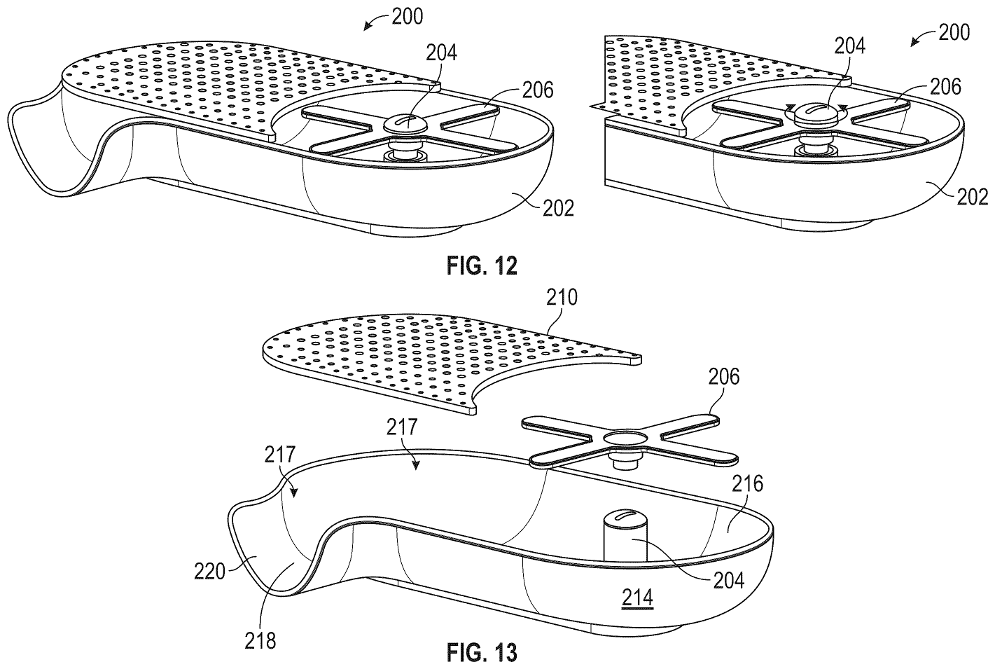

Referring to FIG. 12, the trigger 206 is configured to move downwardly along the nozzle body 204 to actuate or open a valve assembly (not shown, as described above), thereby allowing fluid to be discharged from nozzles 208. As described above, the nozzle body 204 may or may not move with the trigger 206. A valve assembly (not shown) housed in the nozzle body 204, rinser body 202, or in a mounting assembly (not shown) or below deck (not shown) is then opened to allow fluid to be discharged nozzles 208. In an example, the nozzle body 204 rotates upon actuation, thereby spraying fluid, such as water, ozonated water, soapy water, or other disinfectant, in and around in an interior of the vessel until the downward force on the trigger 206 is removed, at which time the trigger 206 moves to its starting position and the valve assembly closes.

A mounting assembly (not shown) and as described above couples the vessel rinsing device to sink deck or other surface, and provides a fluid connection to a fluid source, again as described above.

Referring to FIG. 13, both the caddy surface 210 and the trigger 208 may be easily removed from the rinser body 202 and the nozzle body 204 for rinsing, cleaning, dishwashing, or replacing.

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples may comprise a combination of different individual features selected from different individual examples, as understood be persons of ordinary skill in the art. Moreover, elements described with respect to one example may be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed:

1. A vessel rinsing device comprising:
a mounting element including a base;
a nozzle body extending upwardly from the base along a longitudinal axis, the nozzle body being operably coupleable to a fluid source of dispensing fluid therefrom; and
a rinser body mounted to the base, the rinser body including a sidewall forming a bowl, and a collar forming an aperture through which the nozzle body is configured to extend to mount the rinser body to the base.

2. The vessel rinsing device of claim 1, wherein the nozzle body includes a nozzle formed in a terminal end of the nozzle body, and wherein the vessel rinsing device further comprises a valve assembly positioned within an interior of the nozzle body, the valve assembly being shiftable between a closed state wherein no fluid is dispensed from the nozzle, and an opened state wherein fluid is dispensed from the nozzle.

3. The vessel rinsing device of claim 2, wherein an internal surface of the bowl is configured to a support a vessel placed thereon, and wherein upon application of a downward force on the bowl, the bowl is configured to move along the longitudinal axis of the nozzle body, the valve assembly is shifted from a closed state to an opened state, and the device is configured to dispense fluid from the nozzle.

4. The vessel rinsing device of claim 3, wherein upon application of the downward force, the nozzle body is configured to rotate while dispensing fluid from the nozzle.

5. The vessel rinsing device of claim 1, wherein the sidewall includes structure defining a channel terminating in an opening in the sidewall for draining fluid out of the bowl.

6. The vessel rinsing device of claim 1, wherein an internal surface of the bowl is formed of a hydrophobic material, or includes a layer of the hydrophobic material thereon.

7. The vessel rinsing device of claim 6, wherein the hydrophobic material comprises silicon.

8. The vessel rinsing device of claim 1, wherein at least one of the base, the nozzle body, and the bowl includes one or more light-emitting diodes for providing illumination during vessel cleaning operations.

9. A vessel rinsing device system, the system comprising:
an elongate rinsing body securable to a sink deck or other surface, the rinsing body having a sidewall;
a vessel rinsing device including a nozzle body extending through and into the rinsing body, the nozzle body being fluidly couplable to a fluid source; and
a removable caddy surface adjacent the nozzle body.

10. The vessel rinsing device system of claim 9, wherein the sidewall includes structure defining a drain channel formed in the rinser body sidewall for draining fluid from the rinsing body.

11. The vessel rinsing device system of claim 10, wherein the drain channel is at a first end of the elongate rinsing body, and the vessel rinsing device is at a second end of the rinsing body.

12. The vessel rinsing device system of claim 9, wherein the nozzle body includes a nozzle formed in a terminal end of the nozzle body, and wherein the vessel rinsing device further comprises a valve assembly positioned within an interior of the nozzle body, the valve assembly being shiftable between a closed state wherein no fluid is dispensed from the nozzle, and an opened state wherein fluid is dispensed from the nozzle.

13. The vessel rinsing device system of claim 12, further comprising a trigger including a plurality of extending arms coupled to and extending radially from the nozzle body, wherein the trigger is configured to moved downwardly along the nozzle body to actuate a valve assembly for fluid discharge.

14. The vessel rinsing device system of claim 12, further comprising a trigger plate or trigger bowl coupled to the nozzle body, wherein the trigger plate or trigger bowl is configured to move downwardly along the nozzle body to actuate a valve assembly for fluid discharge.

15. The vessel rinsing device system of claim 12, wherein upon application of the downward force, the nozzle body is configured to rotate while dispensing fluid from the nozzle.

16. A vessel rinsing device comprising:
a mounting element including a base;
a nozzle body extending upwardly from the base along a longitudinal axis, the nozzle body being operably coupleable to a fluid source of dispensing fluid therefrom and having a nozzle at a terminal end of the nozzle body; and
a rinser body mounted to the base, wherein the rinser body is configured to move along the longitudinal axis of the nozzle body upon application of a downward force to the rinser body to actuate a fluid discharge from the nozzle,
wherein the nozzle body is configured to rotate upon application of the downward force.

17. The vessel rinsing device of claim 16, wherein the rinser body includes a sidewall forming a bowl, and a collar forming an aperture through which the nozzle body is configured to extend to mount the rinser body to the base.

18. The vessel rinsing device of claim 17, wherein the vessel rinsing device further comprises a valve assembly positioned within an interior of the nozzle body, the valve assembly being shiftable between a closed state wherein no fluid is dispensed from the nozzle, and an opened state upon application of the downward force.

19. The vessel rinsing device of claim 17, wherein the sidewall includes structure defining a channel terminating in an opening in the sidewall for draining fluid out of the bowl.

20. The vessel rinsing device of claim 16, wherein the vessel rinsing device is configured to dispense water, ozonated water, soapy water, disinfectant, or combinations thereof upon application of the downward force.
